(19) United States
(12) Patent Application Publication
(10) Pub. No.: US 2014/0001299 A1
(43) Pub. Date: Jan. 2, 2014

(54) SEATBELT RETRACTORS AND ASSOCIATED METHODS OF MANUFACTURE AND USE

(71) Applicant: Christopher Meyer, Cassopolis, MI (US)

(72) Inventor: Christopher Meyer, Cassopolis, MI (US)

(73) Assignee: AmSafe Commercial Products, Inc., Elkhart, IN (US)

(21) Appl. No.: 12/950,685

(22) Filed: Nov. 19, 2010

Related U.S. Application Data
(60) Provisional application No. 61/263,210, filed on Nov. 20, 2009.

(51) Int. Cl. B60R 22/34

(52) U.S. Cl. CPC B60R 22/34
USPC 242/384.6; 29/428

(57) ABSTRACT

Web retractors for use in seatbelt systems and other restraint systems are disclosed herein. Web retractors configured in accordance with aspects of the present disclosure can include one or more self cleaning features. For example, one embodiment of a web retractor can include a lock assembly that at least partially immobilizes a spool assembly. The retractor can further include lock assembly housing at least partially covering the lock assembly. The lock assembly housing can include a sidewall portion having one or more drain openings to allow dirt, mud, water, or other unwanted debris to exit the lock assembly housing.

### CROSS-REFERENCE TO RELATED APPLICATION

The present application claims priority under 35 USC §119(e) of U.S. Provisional Application No. 61/263,210, filed Nov. 20, 2009, the disclosure of which is incorporated herein by reference in its entirety.

### TECHNICAL FIELD

The following disclosure relates generally to seatbelt web retractors.

### BACKGROUND

Seatbelt systems for use in cars, trucks, and other vehicles typically include a belt or web that can be pulled from a retractor on one side of the wearer and extended across the wearer's body. The free end of the web typically carries a connector tongue that can be releasably engaged with a buckle anchored to the base of the seat or the floor opposite the web retractor. The web retractor typically includes a spring-loaded spool that maintains tension on the web and retracts it when not in use.

Many off-road utility and recreational vehicles (e.g., “side-by-side” ATVs, etc.) include seatbelt systems. This type of vehicle is often used for work or recreation in harsh, off-road conditions, and the seating areas are typically open to the environment. As a result, the web retractor and other components of the seatbelt system may be exposed to dirt, mud, debris, water, etc. during normal use.

### BRIEF DESCRIPTION OF THE DRAWINGS

FIG. 1 is a side view of an occupant seated in a vehicle having a seatbelt system with a web retractor configured in accordance with an embodiment of the present disclosure.

FIGS. 2A-2C are a series of isometric views of a web retractor configured in accordance with an embodiment of the present disclosure, and FIG. 2D is an end view of the web retractor illustrating various features in more detail.

FIGS. 3A and 3B are side views of a retractor locking mechanism having various features configured in accordance with embodiments of the present disclosure, and FIGS. 3C and 3D are partial isometric views of the retractor locking mechanism.

FIG. 4A is an isometric view of a retractor locking mechanism housing configured in accordance with an embodiment of the present disclosure, and FIGS. 4B and 4C are partially exploded isometric views of the locking mechanism housing illustrating some features of the web locking mechanism.

FIG. 5A is a rear isometric view of the retractor locking mechanism housing illustrating various features configured in accordance with embodiments of the present disclosure, and FIG. 5B is a partially exploded isometric view of the retractor locking mechanism housing illustrating additional features configured in accordance with embodiments of the present disclosure.

FIG. 6 is an enlarged isometric view of a retractor wheel lock arm configured in accordance with an embodiment of the present disclosure.

### DETAILED DESCRIPTION

The following disclosure describes various embodiments of seatbelt web retractors, such as retractors for use in seatbelt systems on all terrain vehicles (ATVs) and other types of utility and recreational vehicles which may be exposed to dirt, mud, sand and the like during use. Web retractors used in side-by-side ATVs, for example, may be used in very muddy conditions or even submerged in muddy water for short periods of time. As a result, mud and dirty water can find its way into the retractor and build up over time. As described in greater detail below, web retractors configured in accordance with aspects of the present disclosure can include various features (e.g., drainage features, etc.) that allow mud and/or other foreign matter to flow out of the retractor before building up.

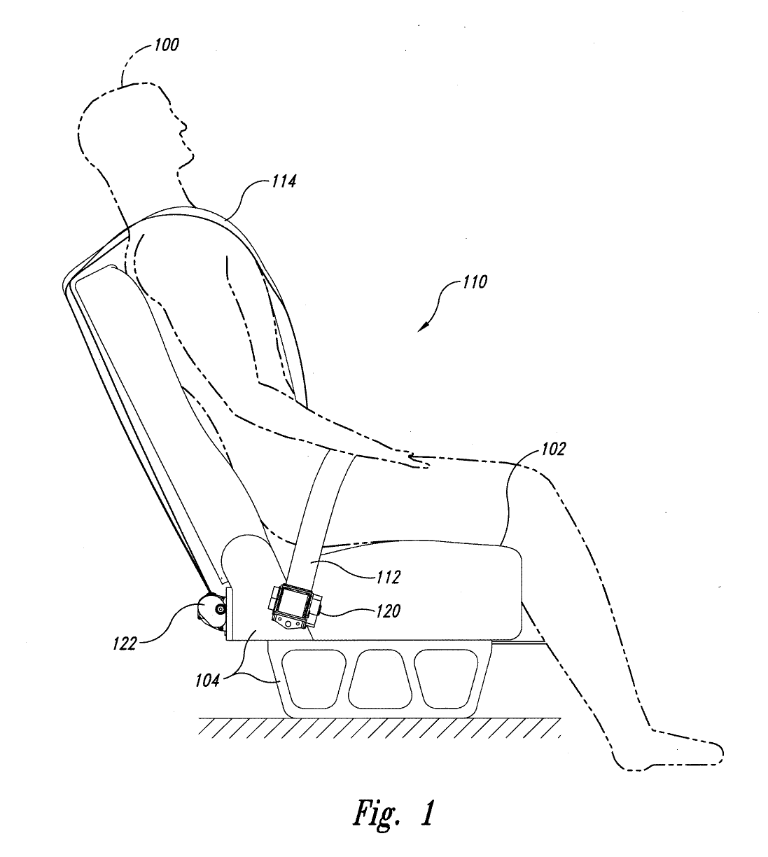

Certain details are set forth in the following description and FIGS. 1-6 to provide a thorough understanding of various embodiments of the disclosure. Other details describing well-known structures and systems often associated with occupant restraint systems, seatbelt web retractors, and other related systems, however, have not been set forth in the following disclosure to avoid unnecessarily obscuring the description of the various embodiments of the invention.

Many of the details, dimensions, angles and other features shown in the Figures are merely illustrative of particular embodiments of the invention. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is a side view of a person 100 secured to a vehicle seat 102 with a restraint system 110 having a web retractor 120 configured in accordance with an embodiment of the disclosure. In the illustrated embodiment, the restraint system 110 can be a seatbelt system used to secure the person 100 in, for example, an ATV, ORV, or other vehicle (e.g., other open vehicles) that may be exposed to harsh and/or dirty environments. The web retractor 120 can be fixedly attached to a seat frame 104, and can include a spring-loaded spool (not shown in FIG. 1) that carries a lap belt or web 112 wound thereon. The web 112 can be a conventional seatbelt web made of woven material known in the art. The web 112 can be used in conventional fashion by extracting the web 112 from the retractor 120 and coupling a connector on the distal end of the web (not shown in FIG. 1) into a buckle that is suitably anchored to the seat base 104 or the floor of the vehicle on the opposite side of the seat 102.

The restraint system 110 can additionally include one or more shoulder belts 114 that can also be carried and deployed from one or more retractors 122 anchored to a rear portion of the seat base 104. Although FIG. 1 illustrates one configuration of seatbelt system, those of ordinary skill in the art will appreciate that the web retractors disclosed herein can be suitably employed in a wide variety of seatbelt systems and in virtually any type of vehicle in which a seatbelt web retractor is used. Accordingly, those of skill in the art will understand that the web retractors described herein are not limited to use in any particular configuration.

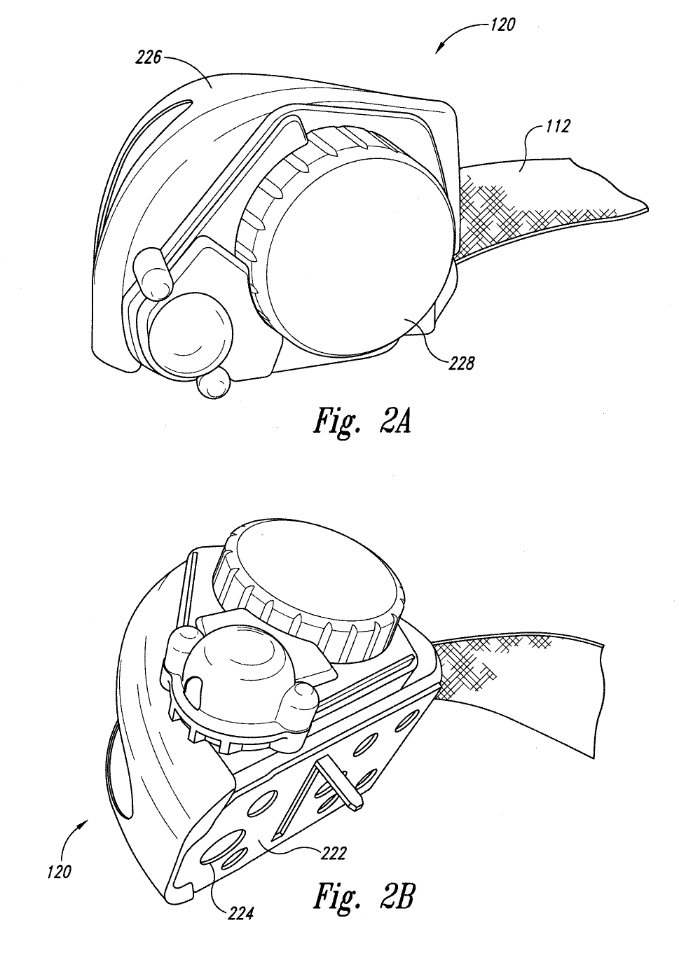

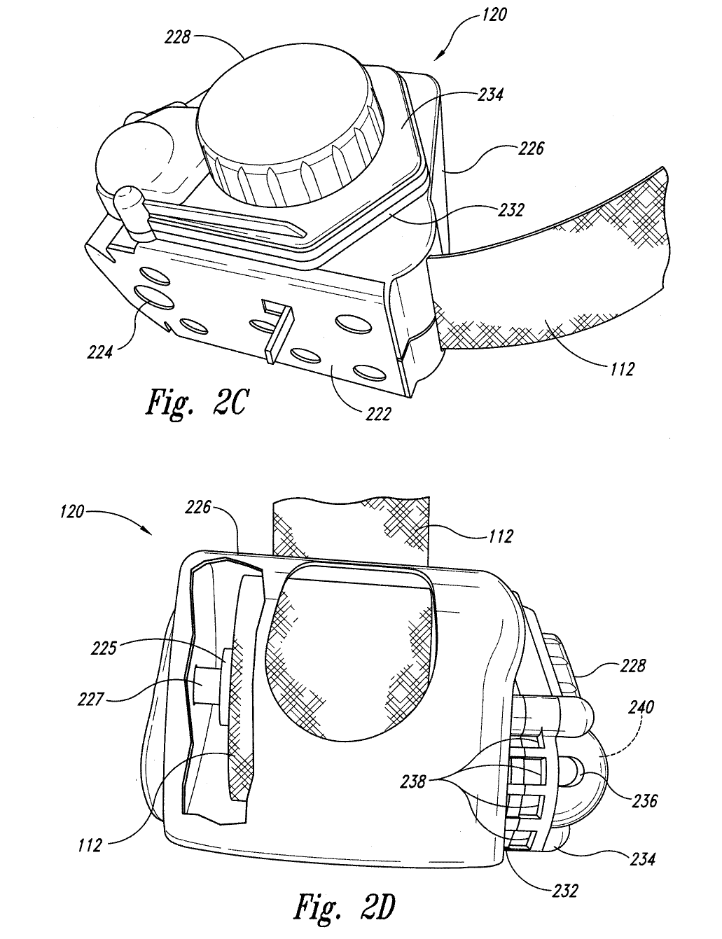

FIGS. 2A-2D are a rear isometric, bottom-rear isometric, bottom-front isometric, and partially cut-away rear view, respectively, of the web retractor 120. Referring to FIGS. 2A-2D together, in the illustrated embodiment, the web retractor 120 includes a web locking mechanism housing 228 attached to a side wall of a spool housing 226. The locking mechanism housing 228 and the spool housing 226 can be formed from plastic (e.g., injection-molded plastic) and/or other suitable materials known in the art. The spool housing 226 can house a spool 225 having a spring-loaded shaft 227 that rotates in a first direction to wind the web 112 about the spool 225 and retract the web 112 into the housing 226 in a conventional manner. The spool 225 can also rotate in the opposite direction to allow a user to extract the web 112 from the spool housing 226 in a conventional manner.

As shown in FIG. 2C, the locking mechanism housing 228 can include a bottom cover 232 that is snapped together and/or otherwise attached to a top cover 234 in a clam-shell manner. As described in greater detail below, the locking mechanism housing 228 can house a spool or web locking mechanism that utilizes counterweights to engage teeth on a lock ring and lock the spool 225 when the web 112 is extracted from the spool 225 at or above a preset rate. The locking mechanism can also include an actuator or sensor ball (e.g., a steel sensor ball) that can move under rapid deceleration (e.g., such as an accident) or when the retractor 120 achieves a particular orientation, and thereby lock the spool shaft 227. The sensor ball is movably contained in a ball cavity or compartment 240 formed in the upper cover 234 of the locking mechanism housing 228.

As described in greater detail below, mud, muddy water, dirt, sand, etc. can find its way into the locking mechanism housing 228 and collect inside the ball compartment 240 during use. For example, mud (muddy water) can find its way through the bearings of the spool 225 and frame assembly. It can also seep in around the perimeter of the top and bottom covers 234/232 that protect the locking mechanism. In one aspect of the present disclosure, the upper cover 234 and the lower cover 232 can include one or more “self-cleaning” or dirt/mud resistant features. For example, the upper cover 234 can include a drain hole or aperture 236 adjacent to the ball compartment 240, and the lower cover 232 can include one or more lower drain holes or apertures 238 adjacent the ball compartment 240. As described in greater detail below, these apertures form open passages into the ball compartment 240 that allow mud and/or other forms of dirt to flow out of the locking mechanism housing 228 before it can collect and/or build up inside the housing.

As shown in FIGS. 2B and 2C, the retractor 120 can further include a frame with a base plate 222 that carries the spool housing 226. The base plate 222 can be formed from a suitable metal (e.g., stamp-formed from suitable metal sheet or plate, cast, forged, etc.), and can include one or more holes or apertures 224 to receive a bolt or other suitable fastener for fixedly attaching the retractor 120 to the seat base 104 (FIG. 1).

In the illustrated embodiment, the spool 225 and various other portions of the retractor 120 can be at least generally similar in structure and function to the retractors provided by Hornling Industrial Inc., of 167 Gong Ming Road, Tainan Taiwan. As those of ordinary skill in the art will appreciate, however, the various self-cleaning features and other features described herein are not limited to use with a particular type of web locking mechanism or retractor, but may be advantageously employed with other types of web retractors having other types of spool or web locking mechanisms without departing from the spirit or scope of the present disclosure. Accordingly, aspects of the present disclosure are not limited to any particular type of web retractor.

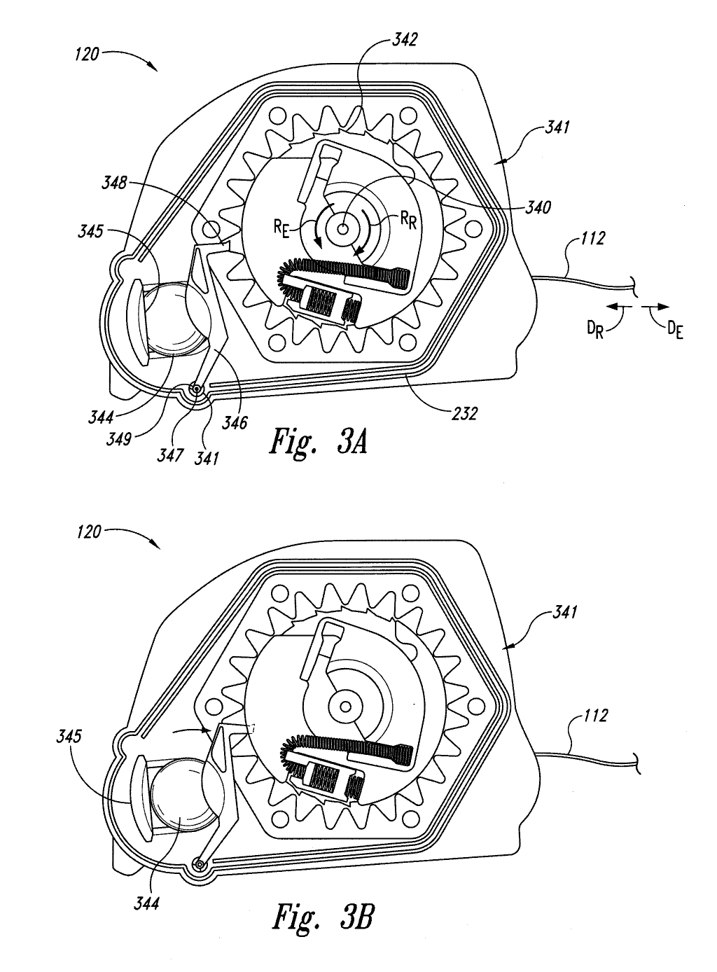

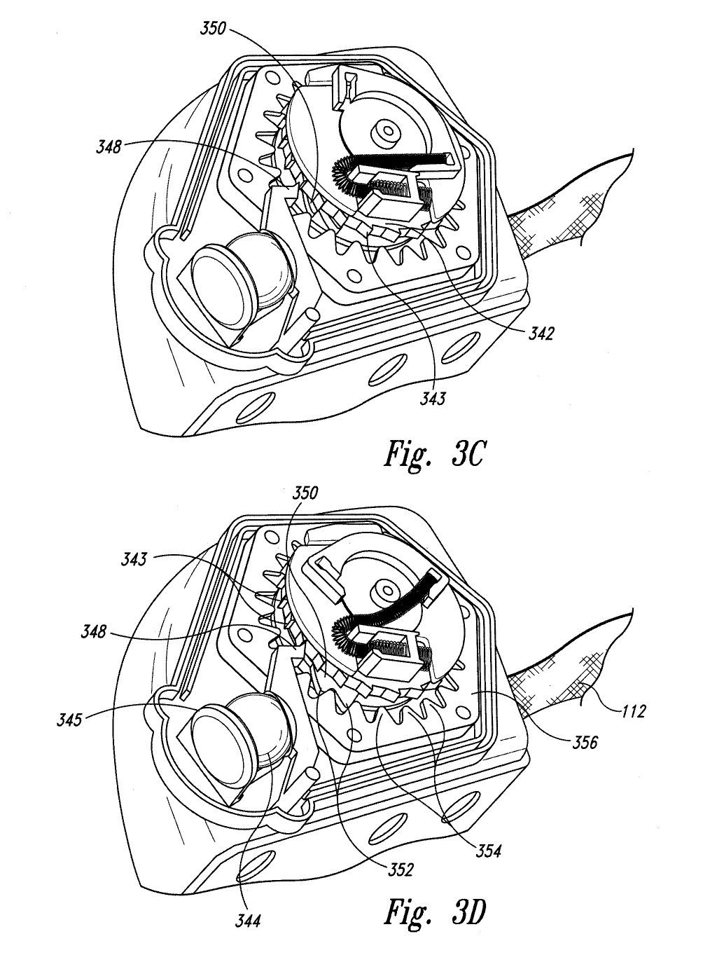

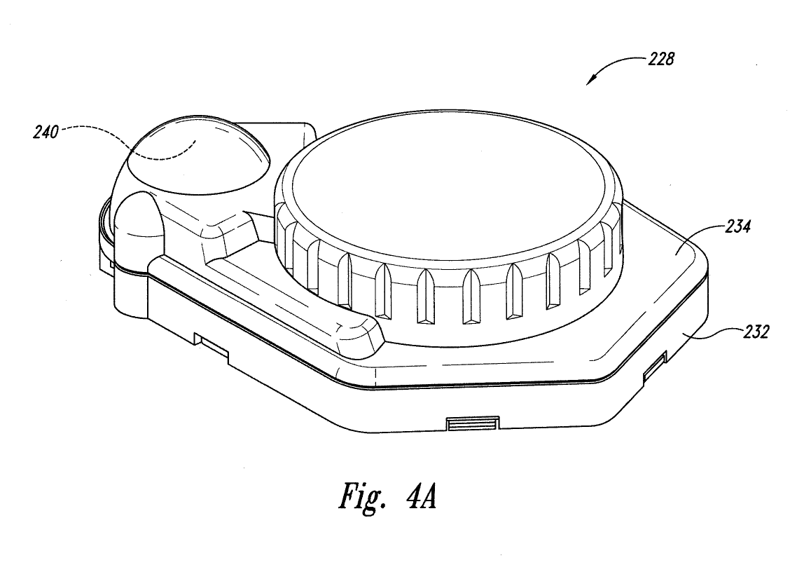

FIGS. 3A and 3B are side views of the web retractor 120 with the upper locking mechanism cover removed, and FIGS. 3C and 3D are partially isometric side views of the retractor 120 with the upper locking mechanism cover removed to illustrate various operational aspects of a web locking mechanism 341. Referring first to FIGS. 3A and 3B, the locking mechanism 341 includes an inertia wheel or lock wheel 342 that is attached to the shaft 227 (FIG. 2D) and rotates about an axis 340 coaxially aligned with the shaft 227. When the web 112 is pulled out of the retractor 120 in a first direction DE, the lock wheel 342 rotates in a first direction RE. Conversely, when the spool draws the web 112 back into the retractor 120 and a second direction DR, the lock wheel 342 rotates in the opposite direction RR.

An actuator or sensor ball 344 is operably positioned between a support or ball cup or basket 345 and a pivotal lock arm 346. In various embodiments, the ball 344 can be formed from suitable metallic materials, such as iron, stainless steel, chrome plated steel, etc. The lock arm 346 has a proximal end portion 349 that is pivotally received in a socket 341 and is configured to pivot about an axis 347. When the sensor ball 344 moves relative to the basket 345, it pushes the lock arm 346 outwardly, causing a distal end portion 348 of the lock arm 346 to pivot toward the lock wheel 342, as shown in FIG. 3B. As described in greater detail below, the distal tip portion 348 is configured to engage one of a plurality of teeth 343 disposed around the perimeter of the locking wheel 342. The locking wheel 342, the lock arm 346, the basket 345 and/or various portions thereof can be formed from suitable materials known in the art, such as injection molded plastics, nylon, Delrin®, etc.

As shown in FIGS. 3C and 3D, inertial counterweights 350 are pivotally coupled to the shaft 227 underneath the lock wheel 342. A stationary lock ring 356 having a plurality of teeth 354 is fixedly attached to the retractor body around the outside of the lock wheel 342. When the distal tip portion 348 of the lock arm 346 engages one of the teeth 343 on the lock wheel 342, continued extraction of the web 112 drives the counterweights 350 outwardly until teeth 352 on the counterweights 350 engage and butt against the teeth 354 on a lock ring 356. This stops the spool 225 (FIG. 2D) from rotating and temporarily prevents further extraction of the web 112.

When the retractor 120 is exposed to mud, dirt, and/or other potentially detrimental substances during use, these substances can build up in and around the ball 344, the basket 345, the lock arm 346, etc. In one aspect of the present disclosure, however, the locking mechanism housing 228 can include one or more drain holes and/or other features that facilitate movement of dirt and other foreign matter out of the housing.

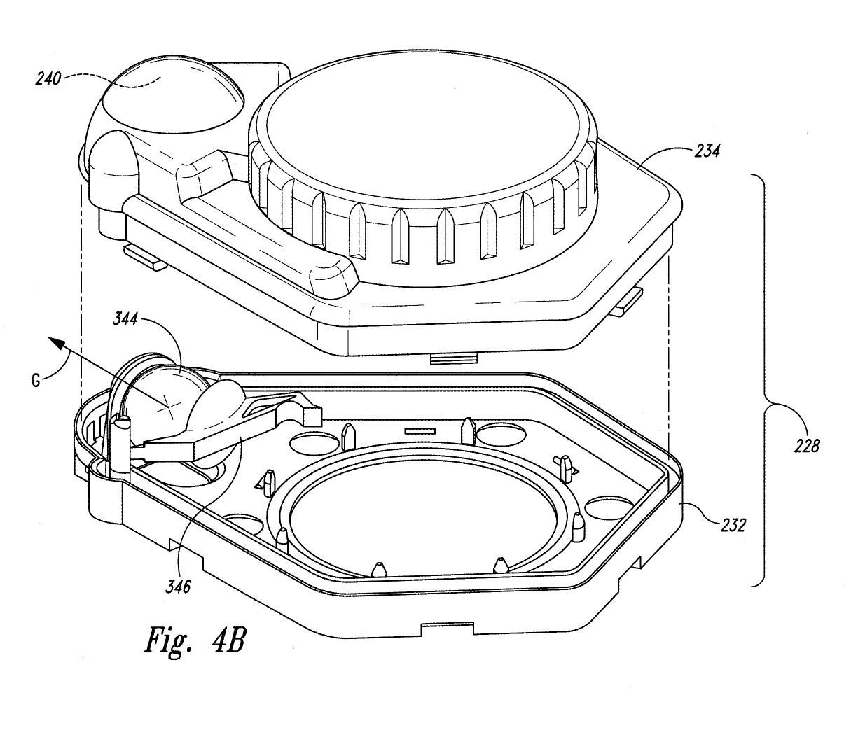

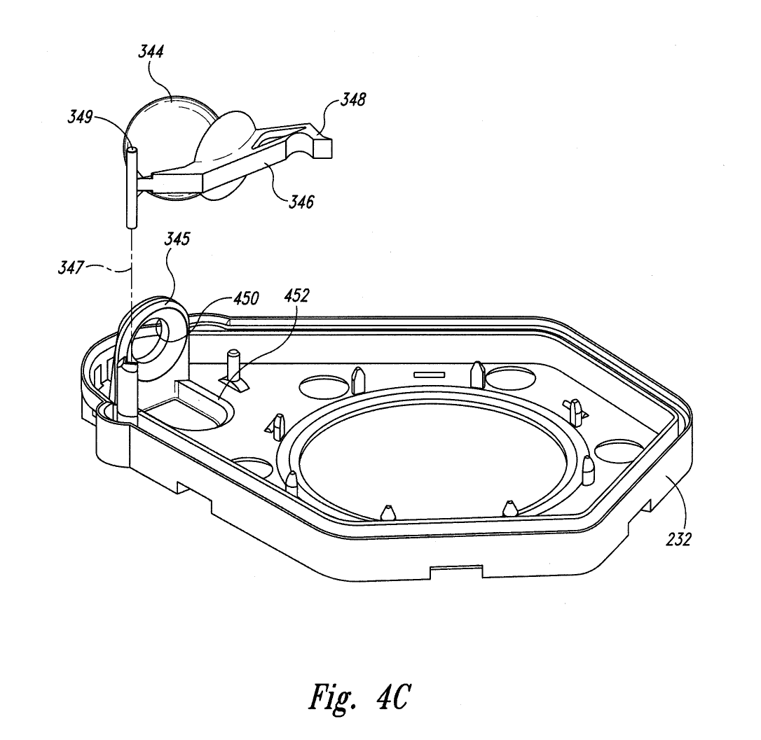

FIG. 4A is an isometric view of the locking mechanism housing 228, and FIGS. 4B and 4C are partially exploded isometric views of the locking mechanism housing 228 and some of the internal components. Referring to FIGS. 4A-4C together, the sensor ball 344 is movably contained in the locking mechanism housing 228 in the ball compartment 240. As shown in FIG. 4B, the ball 344 is generally seated in the basket 345 when the retractor 120 is oriented so that gravity is acting in a general direction G. If the vehicle experiences a rapid deceleration or acceleration of sufficient magnitude and direction, or if the retractor moves to a sufficiently different orientation, the ball 344 will move relative to the basket 345 (but not through the basket in the direction G). For example, the ball 344 can drop down and move back and forth along a ball track 452 formed in a lower portion of the lower cover 232. As shown in FIG. 4C, the basket 345 includes a central opening or aperture 450 located coaxially therein. In one aspect of this embodiment, the aperture 450 permits mud, dirt, and other matter from building up in the base of the basket 345 and adversely affecting ball movement, such as the ability of the ball 344 to move back into the seat formed by the basket 345.

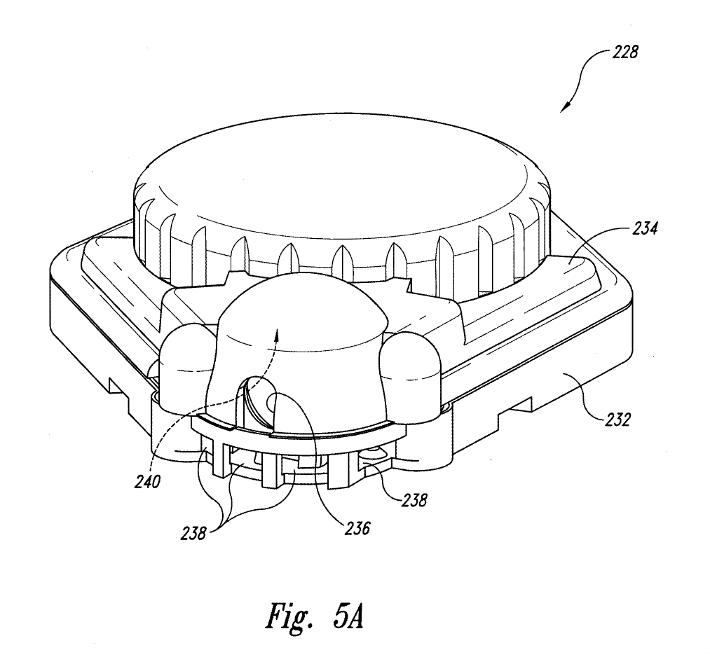

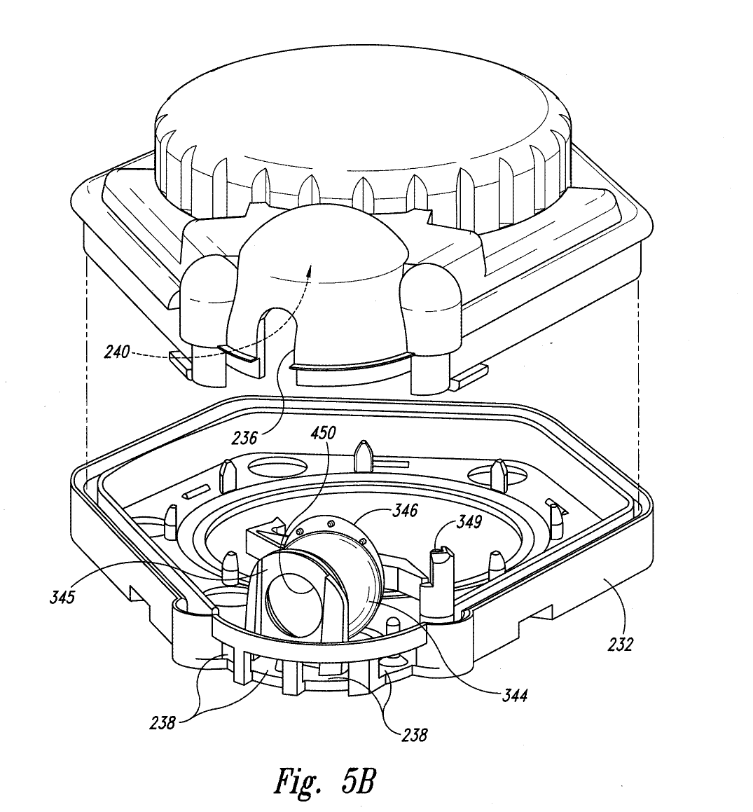

FIG. 5A is a rear isometric view of the locking mechanism housing 228, and FIG. 5B is a corresponding partially exploded isometric view of the locking mechanism housing. Referring to FIGS. 5A and 5B together, in the illustrated embodiment the upper drain hole 236 is a mouse-hole shaped cutout (e.g., an arc portion connecting a generally straight first side portion with a corresponding generally straight second side portion) in the lower edge portion of the upper cover 234 adjacent to the ball compartment 240. This opening can allow mud, dirty water, etc. to flow out of the locking mechanism housing 228 and avoid buildup. The lower drain holes 238 extend through a sidewall portion of the lower cover 232 below the ball compartment 240 outboard of the ball basket 345. These openings also facilitate the flow of mud, dirt and other undesirable matter out of the locking mechanism housing 228. Accordingly, the holes 236 and 238 form open passages in fluid communication with the ball compartment 240, and are shaped and sized to avoid or reduce build up of dirt and/or other foreign matter in and around the locking mechanism components during repeated use in dirty or otherwise adverse conditions.

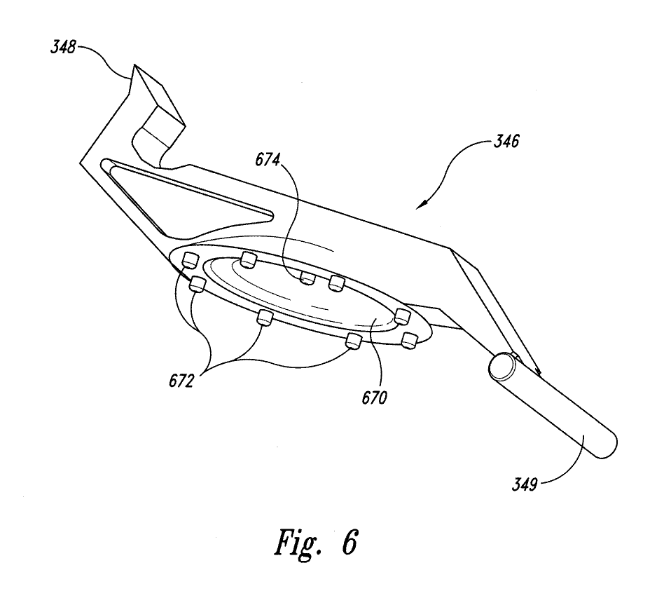

FIG. 6 is an enlarged isometric view of the lock arm 346 configured in accordance with an embodiment of the disclosure. As this view illustrates, the lock arm 346 includes a concave ball-receiving portion 670 positioned between the distal end portion 348 and the proximal end portion 349. In the illustrated embodiment, the ball-receiving portion 670 can have a concave or cup-like relief configured to receive a portion of the outer surface of the ball 344 adjacent thereto. In a further aspect of this embodiment, the ball-receiving portion 670 can include a plurality of stand-offs or risers 672 extending outwardly from the lock arm 346 toward the ball 344. The risers 674 can be placed around the perimeter of the ball-receiving portion 670. In addition, the ball-receiving portion 670 can also include a central riser 674 proximate to the center of the ball-receiving portion 670. The risers 672 and 674 can be configured to interface with the surface of the ball 344 as it moves relative to the ball-receiving portion 670.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. A retractor assembly for retracting a web, the retractor assembly comprising:
a spool subassembly including
a spool; and
a spool shaft coaxial with the spool, wherein the spool shaft rotates in a first direction to wind the web about the spool and a second direction opposite the first direction to unwind the web from the spool;
a spool housing at least partially covering the spool subassembly;
a spool locking subassembly proximate to the spool subassembly, the spool locking subassembly including
a lock wheel coupled to the spool shaft;
a pivot arm movable between a locked position and an unlocked position, wherein in the locked position the pivot arm engages the lock wheel and at least partially immobilizes the spool shaft; and
a sensor ball movable between a first position and a second position, wherein as the sensor ball moves from the first position to the second position the sensor ball contacts the pivot arm and at least partially urges the pivot arm toward the locked position; and
a locking subassembly housing adjacent to the spool housing, the locking subassembly housing including
a sensor ball compartment that supports the sensor ball in the first and second positions; and
a wall portion of the sensor ball compartment, the wall portion having a drain opening therein that is in open fluid communication with the sensor ball compartment.

2. The retractor assembly of claim 1 wherein the drain opening comprises a first opening, and wherein the retractor assembly further comprises a plurality of drain openings in the wall portion of the sensor ball compartment.

3. The retractor assembly of claim 1 wherein the sensor ball compartment further includes:
a track portion having a first drain aperture in the sensor ball compartment, wherein the sensor ball moves along at least a section of the track portion between the first and second positions; and
a ball basket portion adjacent to the track portion, wherein the ball basket portion includes a second drain aperture in the sensor ball compartment, and wherein in the first position the sensor ball contacts the ball basket portion and in the second position the sensor ball is spaced apart from the ball basket portion.

4. The retractor assembly of claim 3 wherein the ball basket portion extends generally perpendicularly away from the track portion.

5. The retractor assembly of claim 3 wherein the sensor ball at least partially covers each of the first and second drain apertures when the sensor ball is in the first position.

6. The retractor assembly of claim 1 wherein the locking subassembly housing comprises a first cover adjacent to a second cover, and wherein the drain opening is a first drain opening in a sidewall of the first cover, and wherein the locking subassembly housing further comprises a second drain opening in a sidewall of the second cover.

7. The retractor assembly of claim 6 wherein the first drain opening includes an arc portion connecting a generally straight first side portion with a corresponding generally straight second side portion.

8. The retractor assembly of claim 6 wherein the second drain opening has a generally rectangular shape.

9. The retractor assembly of claim 6 wherein the first drain opening has a different shape than the second drain opening.

10. The retractor assembly of claim 1 wherein the ball sensor moves between the first and second positions in response to the force of gravity.

11. The retractor assembly of claim 1 wherein the drain opening is configured to allow at least one of dirt, mud, water, or other contaminants to exit from the locking subassembly housing.

12. A retractor comprising:
a spool assembly configured to wind and/or unwind a web;
a locking assembly configured to at least partially immobilize the spool assembly, the locking assembly including
a lock wheel coupled to the spool assembly;
a lock arm movable to contact the lock wheel; and
an actuator movable between a first position and a second position, wherein as the actuator moves from the first position toward the second position, the actuator at least partially biases the lock arm to contact the lock wheel; and
a housing at least partially covering the locking assembly, the housing including
a wall portion adjacent to the actuator; and
a drain opening in the wall portion, wherein the drain opening is configured to allow fluid to exit the housing.

13. The retractor of claim 12 wherein the housing includes a first cover adjacent to a second cover, and wherein the drain opening includes a first drain opening in the first cover and a second drain opening in the second cover, wherein the second opening is separate from the first opening.

14. The retractor of claim 12 wherein the drain opening includes a plurality of exit apertures arranged in an array at least partially surrounding the actuator.

15. The retractor of claim 12, further comprising an actuator support, wherein the actuator is operably positioned between the actuator support and the lock arm, wherein the actuator contacts the actuator support when the actuator is in the first position, and wherein the actuator moves away from the actuator support as the actuator moves toward the first position.

16. The retractor of claim 15 wherein the support includes an aperture extending therethrough, wherein the aperture is generally aligned with the actuator.

17. A method of manufacturing a retractor assembly, the method comprising:
at least partially covering a spool assembly and a lock assembly with a housing, wherein:
the spool assembly is configured to wind and/or unwind a web; and
the lock assembly is configured to at least partially immobilize the spool assembly, and includes a lock arm movable to engage the spool assembly, and a sensor ball movable from a first position toward a second position to urge the lock arm to engage the spool assembly; and
forming at least one drain opening in a wall portion of the housing adjacent to the lock assembly, wherein the drain opening is in open fluid communication with an interior portion of the housing.

18. The method of claim 17 wherein forming at least one drain opening comprises forming a first drain opening spaced apart from an array of multiple second openings, wherein the first drain opening is larger than corresponding individual second drain openings.

19. The method of claim 17 wherein:
at least partially covering the spool assembly and the lock assembly with the housing comprises at least partially covering the lock assembly with a first cover adjacent to a second cover; and
forming at least one drain opening comprises forming a first drain opening in a first sidewall of the first cover and forming the second drain opening in a second sidewall of the second cover.

20. The method of claim 17 wherein forming the first drain opening comprises forming a first drain opening having an arc portion connecting a generally straight first side portion with a corresponding generally straight second side portion, and forming the second drain opening comprises forming a plurality of spaced apart second drain openings, wherein individual second drain openings have a generally rectangular shape.
